(19) United States
(12) Patent Application Publication
(10) Pub. No.: US 2004/0218958 A1
(43) Pub. Date: Nov. 4, 2004

(54) Method and device for printing mail

(76) Inventors: Jurgen Kruger, Vlotho (DE); Horst Emrich, Muhltal (DE); Rainer Anthonj, Offenburg (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/795,550

(22) Filed: Mar. 8, 2004

Related U.S. Application Data
(63) Continuation of application No. PCT/DE02/02904, filed on Aug. 7, 2002.

(30) Foreign Application Priority Data
Sep. 24, 2001 (DE) 101 46 842.3

(51) Int. Cl. B41J 5/00

(52) U.S. Cl. 400/103

(57) ABSTRACT

A method for printing mail wherein the mail is fed to a printing device by means of conveyor and is printed in the printing device. The mail is fed by a first conveyor associated with a rotating device used to rotate and/or turn the mail; graphic characteristics of at least one surface of the mail are detected during conveyance of the mail; the graphic characteristics thus detected are evaluated, information being obtained from the result of the evaluation of the graphic characteristics determining which surface of the mail is to be printed; the rotating device rotates and/or turns the mail in such a way that the surface of the mail to be printed is oriented in a desired manner and fed to a printer disposed in the printing device.

### CROSS-REFERENCE TO RELATED APPLICATION

This is a continuation of International Application No. PCT/DE02/02904 filed Aug. 7, 2002, the entire disclosure of which is incorporated herein by reference.

### BACKGROUND OF THE DISCLOSURE

1. Field of the Disclosure

The disclosure relates to a method for printing mailpieces, whereby the mailpieces are conveyed and delivered to a printing device, as well as to a device that is suitable for carrying out the method.

2. Related Technology

A method of this general type is described in DE 195 08 180 C2. In this prior-art method, the mailpieces are transported to a printing device on a conveyor belt that runs from a charging station for the mailpieces to the printing device.

U.S. Pat. No. 4,520,932 discloses a device for detecting stamps on mailpieces. The device includes several stamp detectors that are arranged on transport means on which the individuated mailpieces are conveyed. The mailpieces are fed to a first detector that detects stamps that have been applied in the lower area on the front and back of the mailpieces. Mailpieces on which the first detector has detected a stamp are fed to a canceller and provided with a cancellation mark. If the first detector does not detect a stamp, the mailpieces are rotated by 180° in a rotating device and fed to a second detector that detects stamps in the originally upper area of the mailpiece and that likewise controls a canceller.

DE 38 21 106 A1 describes a device for turning over and stamping postal items in which a detector scans the mailpieces and an address block and a writing direction are determined on the basis of the scanned data. A turning device and a stamping device are controlled by a control device as a function of the detection result.

U.S. Pat. No. 6,085,182 discloses a method and a device to cancel postage. The device includes sensors that detect the position of stamps on a mailpiece and transmit this information to a microprocessor that controls several printheads arranged at different levels and that activates those printheads that are at the level of the detected stamps.

### SUMMARY OF THE DISCLOSURE

The disclosure provides an improved method and device for printing mailpieces whereby mailpieces can be printed as quickly and reliably as possible.

According to the disclosure, a mailpiece is transported by a first conveyor, graphic properties of at least one surface of the mailpiece are detected, and the detected graphic properties are evaluated. From the result of the evaluation of the graphic properties, information is acquired as to which surface of the mailpiece is intended for printing, and a printing device and/or conveying of the mailpiece to a printing device is regulated in such a way that the surface of the mailpiece to be printed on is positioned in a desired orientation with respect to a printer.

Evaluation of the graphic properties of the mailpieces and use of the acquired graphic information for regulating subsequent processing steps can be used in a variety of ways. In particular, flexible printing of the mailpieces is made possible.

In a first advantageous embodiment, subsequent processing steps are regulated such that, depending on the information acquired from the result of the evaluation of the graphic properties as to which surface of the mailpiece is intended for printing, one of several devices for printing the mailpiece that are present in the printing device is activated.

In this manner, the desired surface of the mailpiece can be printed especially easily and reliably.

It is preferred that the mailpiece be conveyed to the printing device in such a way that the surface to be printed on lies essentially perpendicular to the printer in the printing device.

Such perpendicular transport makes it possible (optionally dispensing with the use of a turning module) to carry out the method in a device that has a short system length and that is hardly susceptible to failure and that also allows simple further processing, especially in terms of sorting and diverting mailpieces after printing.

However, if a relatively complex printing device is used which allows, for example, the selective printing of individual surface areas of the mailpiece, it is especially advantageous to provide a rotating device for rotating and/or turning over the mailpiece and, in this manner, to deliver the mailpiece to the printer, depending on the result of the evaluation of the graphic properties.

In an especially preferred form of this embodiment of the invention, the mailpiece is transported by a first conveyor to a rotating device for rotating and/or turning over the mailpiece, during which at least a partial step of detection of the graphic properties of at least one surface of the mailpiece takes place, and the detected graphic properties are evaluated. On the basis of the result of this evaluation, information is acquired as to which surface of the mailpiece is intended for printing, and the rotating device rotates and/or turns over the mailpiece in such a way that the surface of the mailpiece to be printed on is conveyed in a desired orientation to a printer in the printing device.

In this embodiment, the mailpiece is transported by the first conveyor to the rotating device for rotating and/or turning over the mailpiece, graphic properties of at least one surface of the mailpiece are detected during transport, and the detected graphic properties are evaluated. On the basis of the result of the evaluation of the graphic properties, information is acquired as to which surface of the mailpiece is intended for printing, and the rotating device rotates and/or turns over the mailpiece in such a way that the surface of the mailpiece to be printed on is delivered in a desired orientation to the printer in the printing device.

This method is especially well-suited for mass processing of mailpieces as is done at mail centers or shipping centers.

The disclosure provides for the evaluation of graphic properties of the mailpieces and, on the basis of the graphic information acquired, for the orientation of the mailpieces with respect to a printer.

The concept of “graphic properties” is meant in its broadest sense and encompasses, in particular, image patterns, markings, or other optical properties that can be evaluated such as, for example, absorption and reflection properties of surface areas of the mailpiece. The reflection properties encompass every variant that can be understood as a reflection in the broadest sense, and especially the detection of the presence of fluorescence. Here, for example, electromagnetic radiation is applied in order to check whether fluorescence phenomena are present.

Surprisingly, it has been found that such a complex method, including the numerous digital processing steps that have to be carried out in order to acquire information from the graphic properties, can be used in mass processing of mailpieces for handling several thousand mailpieces per hour.

It is especially advantageous that the mailpieces can be placed randomly onto the conveyor. In particular, these mailpieces are an essentially continuous stream of mailpieces of the same size or different sizes.

Such random delivery of mailpieces includes the scenario in which individual mailpieces can be overlapping. In order to allow reliable detection of the graphic properties even in such cases, it is advantageous for the mailpieces to pass through individuation modules.

The term “mailpiece” is not to be understood in a restrictive manner and encompasses letters as well as packages and parcels.

The mailpieces may be essentially flat mailpieces that may also be referred to as letters, irrespective of their actual postal classification. The letters may be the familiar types of letters, for example, standard, large and oversized letters.

When the disclosed method and device are integrated into systems for processing letters, it is advantageous for the mailpieces to be conveyed to the printing device by a second conveyor after they have been rotated and/or turned over in the rotating device.

The disclosed method and device may also detect graphic properties in the area of at least one surface of the mailpieces and, on the basis of the acquisition and evaluation of the graphic information, determine an area of the mailpiece to be imprinted and, print the mailpiece in the area to be printed on, for example, with the imprint image thus determined.

In particular, the disclosed method and device make it possible to determine one or more positions for the application of imprints by detecting graphic properties of the surface of the mailpieces.

Here, the imprints can be the same as well as changed (for example, program-controlled) or else adapted individually to each mailing.

A combination of these process steps with a selection of the surface to be printed on is represented in a preferred embodiment wherein, after the rotating and/or turning over of the mailpieces in the rotating device, graphic properties of the mailpieces are again detected and, on the basis of the detected graphic properties, at least one area of the surface to be printed on is selected in which the mailpiece is then printed.

In another advantageous embodiment, the area in which the mailpieces are to be printed is determined by detecting the graphic properties of the mailpieces during transport on the first conveyor. One advantage of this embodiment is that the component configuration is especially simple since the graphic properties needed for rotating and/or turning over the mailpieces as well as for selecting the printing area are detected in a single detection step and, if applicable, with a single detector.

Such refinements of the method are especially advantageous when the method is used to cancel postage stamps that are present on the mailpieces.

Moreover, it is advantageous to provide the mailpieces with the address of the recipient and/or sender. In an especially preferred embodiment, information is acquired about the address of the recipient and/or of the sender of the mailpieces and in the mailpieces are printed with the address of the recipient and/or with a code containing the address of the recipient and/or of the sender. In this embodiment, it is preferred to print the mailpieces with an address of the recipient and/or of the sender that can be defined individually in each case.

An association of the letters with an address to be selected is carried out, for example, by means of database information that links the individual mailpiece to the address to be printed.

Moreover, it is preferred to print the mailpieces with freely designable graphic information, for example, an advertising imprint. By linking existing and/or acquired information with additional data, especially by incorporating, for example, information stored in a database, it is possible to create the advertising imprints on an individualized basis. Thus, all mailpieces of a sender can be provided with an advertising imprint adapted to the individual sender. In this manner, it is possible, for example, to provide all mailpieces of a company with an advertising imprint of the company.

Another advantage of the disclosed method and device is that it allows the handling of letters of different postal classes. For example, if desired, a cancellation mark may be generated only if the mailpieces are provided with a postage stamp. In other cases in which, for example, it is ascertained that the mailpieces had already been franked with another form of postage, such as a postage indicium, such a cancellation is generally not applied.

With the described method and device, franking of letters can be integrated into the processing sequence of the mailpieces. For example, the cancellation of postage stamps as well as the printing of postage indicia onto mailpieces that do not have postage stamps can be carried out in the disclosed device. The utilization of graphic information increases the flexibility in handling the letters.

Moreover, it is advantageous for additional information to be printed. Here, it is especially advantageous for the mailpieces to be printed with a graphic representation of encoded information. An example of this is a multi-digit (for example, 11 to 13-digit) recipient address code that serves for the sorting of the mailpieces in a subsequent processing step.

Another example of encrypted information that may be printed are digital postage indicia that preferably contain encrypted data, for example, about the recipient, the sender or the mailing date in order to prevent fraudulent production.

With the disclosed method and device, such digital postage indicia can be created directly on the basis of graphic information that is present on the surface of the mailpieces.

For example, a digital postage indicium that contains several pieces of identification information in encrypted form such as, for example, address and date information, is generated by acquiring information that is present on the surface of the mailpiece.

Here, for example, the address data detected by one of the detectors is combined with further information by means of a suitable linking mechanism and incorporated into a digital postage indicium. This combination can be carried out, for example, by means of a combining method of the type disclosed in DE 100 20 563 C2, the entire disclosre of which is incorporated herein.

The payment to be made for the generation of the postage indicia can be taken, for example, from a virtual postage account of a postal customer or it can be integrated into another payment system.

The use of a particular payment system is preferably chosen as a function of the specific mail volume of a given customer. Particularly for customers with a relatively small mail volume of up to about fifty mailpieces per day, micro-payment solutions or debits from the postage account can be used. In the case of larger mailings, an interface to other payment applications is suitable, for example, to effect integration into a direct debit transaction system.

It is especially preferred to equip a device for printing mailpieces that includes at least one conveyor and one printing device in such a way that the device includes at least one detector for detecting graphic properties of at least one surface of the mailpiece, that the device has the ability to evaluate the detected graphic properties or that it can be connected to a device for evaluating the detected graphic properties in such a way that the detected graphic properties can be transmitted to the evaluating device and that the device has a controller that allows printing and/or conveying of the mailpiece as a function of the result of the evaluation of the acquired graphic information.

It is advantageous for the controller to control the activation of one of devices for printing the mailpiece.

Moreover, it is advantageous for there to be the ability to change the transport route of a mailpiece as a function of the result of the evaluation of the acquired graphic information.

In order to effectively utilize the printing device, it is advantageous for the device to contain a rotating device for rotating and/or turning over the mailpiece and for the rotating device to be controlled by the controller in such a way that the mailpiece can be rotated and/or turned over as a function of the result of the evaluation of the acquired graphic information.

By creating a link between the information about the sender identity and the particular services to be provided, it is possible to compile and charge for the services on a customer-individualized basis. For example, this also allows invoicing for printing on mailpieces with advertising imprints for which there is a charge, preferably individualized address information, and it also allows invoicing for the generated postage indicia.

The direct generation of the digital postage indicia in the device for printing the mailpieces has the advantage that large numbers of mailpieces can be franked and that a high level of protection against forgery is achieved.

In particular, the disclosed method and device make it possible to print several thousand, preferably two thousand to twenty thousand, mailpieces per hour. This requires suitable conveying speed of the mailpieces, whereby especially conveying speeds between one meter per second and ten meters per second are advantageous. Even at a conveying speed of about two meters per second, several thousand mailpieces per hour can be printed.

The advantages and refinements described refer to the disclosed method as well as to the disclosed device for printing mailpieces.

An especially preferred device for printing mailpieces having a conveyor and a printing device includes at least a first conveyor, a rotating device for rotating and/or turning over the mailpieces, and at least one detector for detecting graphic properties of at least one surface of the mailpiece. The rotating device is configured in such a way that it can rotate and/or turn over the mailpieces as a function of the result of an evaluation of the graphic information.

The rotating and/or turning over of the mailpieces as a function of the result of the evaluation of the detected graphic properties is preferably carried out in that the device has a controller for the rotating device, whereby the controller controls the rotating and/or turning over as a function of the result of the evaluation of the graphic information.

It is preferred that the printing device have a printer printing mailpieces, whereby the printer for printing the mailpieces is configured in such a way that it has several printing areas, and in that the individual printing areas can be activated individually.

In order to achieve a printing result that is especially adapted to the requirements of postal operations, it is advantageous for the printer for printing the mailpieces to be linked to the graphic properties detector in such a way that the areas to be printed can be selected as a function of the graphic information.

An especially preferred embodiment of the device includes an imprint image arrangement with several individual imprint images, whereby the individual imprint images are substantially in the form of cancellation stamps.

The disclosed devices are suited for a wide variety of applications. However, it is especially preferred to use the devices for canceling mailpieces.

The cancellation of mailpieces is advantageously carried out such that the activation of the printing areas is controlled in such a way that at least one cancellation mark is applied onto each postage stamp.

In particular, it is advantageous to use the device for canceling mailpieces as well as for franking other mailpieces.

In a preferred embodiment of the method, the various functions such as, for example, canceling the mailpieces, printing the mailpieces with address information as well as printing the postage indicia are each adapted to the individual mailpieces that are different from each other.

However, it is also possible to use the disclosed device for printing mailpieces in different operating periods for different printing tasks.

In this manner, immediately one after the other and without retooling the device, postage indicia can be canceled by printing, mailpieces can be printed with postage indicia and/or address information, and the devices can be used for other purposes.

In particular, it is advantageous to use the graphic information present on the surface of the mailpieces for payment assurance purposes, that is to say, especially in order to check whether the mailpieces have been franked.

### BRIEF DESCRIPTION OF THE DRAWINGS

Additional advantages, special features and practical refinements of the disclosed method and device are described with reference to the drawings.

The drawings show the following:

FIG. 1—a schematic diagram of the route of a mailpiece, and,

FIG. 2—a surface pattern for printing an envelope.

### DETAILED DESCRIPTION

The following description explains the method and device with reference to an example in which the mailpieces are printed, and whereby the mailpieces are rotated and/or turned over relative to the means as the result of the evaluation of the graphic properties of at least one of their surfaces.

However, the invention also encompasses those cases in which the mailpieces are not rotated or turned over. In such cases, it is advantageous to provide an optionally larger number of printers for printing the mailpieces and to then activate one printer or optionally several suitably positioned printers for printing the mailpieces so as to be able to dispense with the need for rotating and/or turning over the mailpieces as described above.

The disclosed method and device and their disclosed variants and embodiments include a rotating and/or turning over of the mailpieces as well as to the case in which the mailpieces are not rotated and/or turned over.

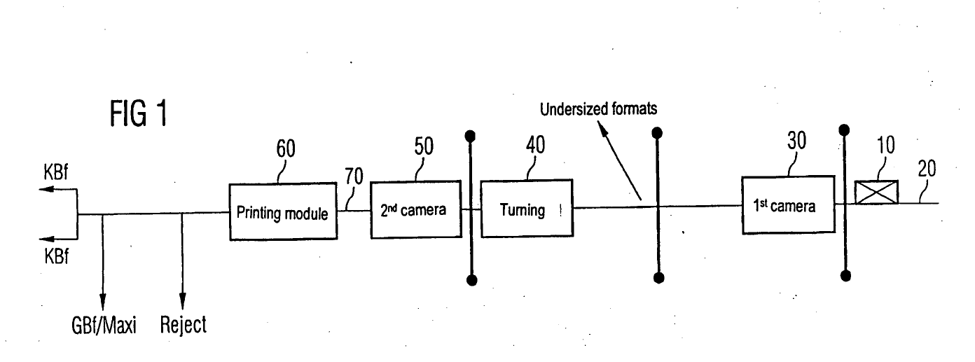

A schematic diagram of the route of the mailpieces depicted in FIG. 1 shows an embodiment in which mailpieces 10 can be conveyed by a first conveyor 20.

In the transport direction, downstream from a depositing station (not shown here) for the mailpieces, there is a first detector 30 for detecting graphic properties of at least one surface of the mailpieces.

The detector 30 can be, for example, a camera linked to an image processing unit. For instance, a device (not shown here for the sake of simplicity) for analyzing the graphic information acquired by the camera has program routines that are capable of recognizing graphic patterns on the surface of the mailpieces.

Suitable pattern comparisons make it possible to check whether the individual mailpieces have been provided with postage stamps whose graphic likeness is stored in a database.

By comparing the stored graphic information with the acquired graphic information, it is possible to determine whether and how many postage stamps are on the surface of the mailpiece.

In the transport direction, downstream from the detector 30, there is a rotating device 40 that can be used for rotating and/or turning over the mailpieces 10.

Downstream from the rotating device 40, there is a second conveyor 70 that can transport the mailpieces 10 from the rotating device 40 to a printing device 60.

A second detector 50, for example, a camera or a sensor, detects positions at which graphic features, especially graphic structures, are located on the surface of the mailpieces 10.

Using the device as shown, a method for printing the mailpieces is preferably carried out as follows:

Mailpieces 10 are placed onto the conveyor 20 and transported by the conveyor 20 to the rotating device 40.

During transport of the mailpieces 10 by the conveyor 20, at least one surface of the mailpieces is detected by the detector 30.

During transport of the mailpieces 10 on the conveyor 20, various diverting steps can be carried out, for example, in order to divert mailpieces having smaller dimensions out of the mailing sequence.

During transport between the detector 30 and the rotating device 40, the former sends the detected graphic properties of the mailpieces to an evaluator means, which links information about the graphic properties of the mailpieces with additional information, especially transport properties of the conveyor, thus determining when a mailpiece should be rotated and/or turned over and making it possible to control the rotating device 40 as a function of the particular mailpiece and of the graphic properties detected for the mailpiece.

In the rotating device 40, the mailpiece 10 is rotated and/or turned over in accordance with the control commands if this is provided for the subsequent orientation of the mailpiece 10 in the printing device 60.

Mailpieces 10 that are already properly oriented pass through the rotating device 40 preferably without their angular position being changed.

After the mailpieces have been processed in the rotating device 40, they are placed onto the second conveyor 70. In the structurally simplified embodiment, the first conveyor 20 and the second conveyor 70 are an integral transport device, for example, a circulating conveyor belt.

During transport of the mailpieces 10 on the second conveyor 70, graphic properties of the mailpieces 10 are once again detected. Preferably, this detection is carried out on the same surface that is also intended for a subsequent printing. In this manner, markings and special features of the graphic properties that have to be observed for the printing procedure can be taken into account. As a result, during the cancellation of the postage stamps, the position of the postage stamps can be determined and the means for printing the mailpieces can be controlled in such a way that at least one printing area is activated that allows the cancellation of the mailpieces.

With this approach, the printing area to be selected can be very precisely adapted to the position of the postage stamp.

For mailpieces that do not have postage stamps, as an alternative, a postage indicium can be printed without this requiring a structural change.

Moreover, it is possible to generate other printed patterns and also to generate these printed patterns as a function of the graphic properties of the surface of the mailpieces.

In this manner, a delivery point encoding in the form of a bar code can be printed on the mailpieces as a function of an address detected on the mailpiece.

It is advantageous for the various areas of application of the imprint images to use differently colored printing inks. For example, a fluorescent marking can be used to generate the delivery point codes, since the fluorescent marking can be more easily detected in a sorting machine that controls a sorting procedure.

The imprint images can be generated in different ways, for example, by means of conventional printing methods such as rotary printing, printing with an inkjet printer, or selective irradiation with laser light. Contact-free or low-contact printing methods such as inkjet printing and laser printing are preferred. Moreover, here the form of the imprint image can be adapted more quickly to changing requirements for printing different letters.

In order to generate cancellation marks, the use of a printing ink that is adapted to the surface of the postage stamps and of the mailpieces is advantageous. The printing ink is advantageously selected in such a way that it penetrates so deeply into the surface areas of the mailpieces that it cannot be removed from the mailpieces. In particular, the printing ink is applied in such a way that penetration of the ink, even through thin envelopes, is prevented.

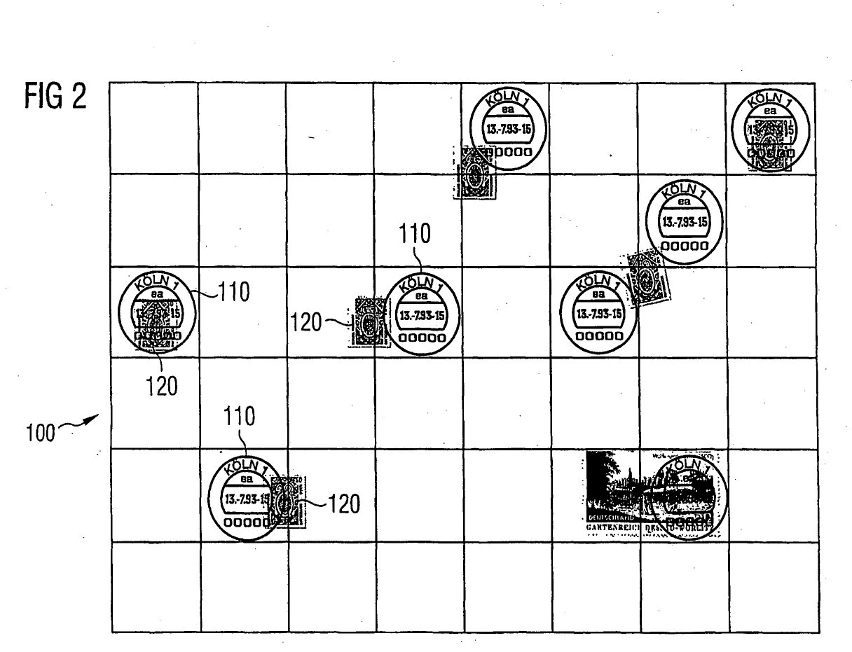

An example of a preferred arrangement of printing areas for canceling mailpieces is shown in FIG. 2, which shows a prescribed surface pattern 100 that ensures the best possible coverage, even over a large surface area of the mailpiece.

As a matter of principle, the components of the surface pattern 100 can be selected at will. The depicted checkerboard arrangement of the printing areas is especially advantageous since this ensures that the cancellation stamps generated by the printing step can be applied anywhere on the surface. This makes it possible to frank mailpieces with postage stamps at any desired place.

The individual printing areas for a cancellation stamp 110 are selected as a function of the individually detected position of the postage stamps 120.

Preferably, the printing area is selected in which the largest piece of each postage stamp 120 is located. In case the virtual largest piece of the postage stamps 120 is located in the area between two printing areas or at the intersection of four printing areas, several imprint images that represent a cancellation stamp can be activated.

A deviation from the printing of the largest piece of the postage stamp 120 can be effected by program control. In this manner, the position of the cancellation stamp 110 can also be adapted to the requirements of stamp collectors.

For example, this makes it possible to provide individual postage stamps 120 with a cancellation stamp on their right-hand edge.

The embodiments shown here are to be understood as mere examples.

In particular, it is advantageous to combine different printing procedures and thus to further increase the processing speed of the mailpieces and to allow the integration of different printing techniques into the processing procedure of the mailpieces.

1. A method for printing mailpieces (10), whereby the mailpieces (10) are conveyed by a transport means (20, 70) to a printing device (60) for printing and graphic properties of at least one surface of the mailpieces (10) are detected and evaluated during transport of the mailpieces (10) to the printing device (60),
characterized in that,
on the basis of an evaluation of the graphic properties detected from the surface of the mailpieces (10) in a first detection means (30), it is checked whether the mailpieces (10) have been provided with a postage stamp (120) and a surface of the mailpieces (10) to be printed on is determined and the mailpieces (10) are rotated and turned over in a rotating device (40) as a function of the result of the evaluation of the graphic properties until they are in a desired orientation, and in that the mailpieces (10) are conveyed in the desired orientation to the printing device (60), while a suitable printing area for printing is selected on the basis of the graphic properties detected in a second detection means (50).

2. The method according to claim 1,
characterized in that,
on the basis of the evaluation of the graphic properties, the type of imprint image is determined and the mailpieces (10) are printed with the determined printing image in the area to be printed on.

3. The method according to one or both of claims 1 and 2,
characterized in that,
depending on the result of the evaluation of the graphic information as to which surface of the mailpiece (10) is intended for printing, one of several means for printing the mailpiece (10) that are present in the printing device (60) is activated.

4. The method according to one or more of the preceding claims,
characterized in that
the mailpiece (10) is conveyed to the printing device (60) in such a way that the surface to be printed on lies essentially perpendicular to the means for printing the mailpiece (10) that are present in the printing device.

5. The method according to one or more of the preceding claims,
characterized in that
numerous mailpieces (10) are placed essentially randomly onto the first conveying means (20).

6. The method according to one or more of the preceding claims,
characterized in that
the mailpieces (10) are separated from each other with an individuation means.

7. The method according to one or more of the preceding claims,
characterized in that
the surface of the mailpiece (10) provided with at least one postage stamp (120) is selected as the surface of the mailpiece (10) to be printed on.

8. The method according to one or more of the preceding claims,
characterized in that
the mailpiece (10) is printed in an area on the surface of the mailpiece (10) for which the presence of a postage stamp (120) has been ascertained.

9. The method according to one or more of the preceding claims,
characterized in that
information is acquired about the address of the recipient and/or of the sender of the mailpiece (10) and in that the mailpieces (10) are printed with the address of the recipient and/or with a code containing the address of the recipient and/or of the sender.

10. The method according to one or more of the preceding claims,
characterized in that
the mailpieces (10) are printed with freely designable graphic information.

11. The method according to one or more of the preceding claims,
characterized in that
the mailpieces (10) are printed with a postage indicium.

12. The method according to one or more of the preceding claims,
characterized in that
the mailpieces (10) are printed with a graphic representation of encoded information.

13. The method according to one or more of the preceding claims,
characterized in that
the encoded information contains the result of an evaluation of the graphic properties of the mailpieces (10).

14. The method according to one or more of the preceding claims,
characterized in that
payment information is determined.

15. The method according to one or more of the preceding claims,
characterized in that
the payment information is linked to information about one or more customers.

16. The method according to one or more of the preceding claims,
characterized in that, by linking the payment information to the customer information, a monetary amount to be paid by that specific customer is determined.

17. A device for printing mailpieces (10), whereby the device comprises at least one conveying means (20, 70), at least one detection means (30, 50) for detecting graphic properties of at least one surface of the mailpieces (10) and one printing device (60),
characterized in that
a first detection means (30) for detecting graphic properties of at least one surface of mailpieces (10) is arranged on a first transport means (20) and is connected to a means for evaluating the detected graphic properties, in that the device has a rotating device (40) for rotating and turning over the mailpieces (10) as a function of the graphic properties detected for the mailpieces (10), in that there is a second conveying means (70) that can transport the mailpieces (10) from the rotating device (40) to the printing device (60), and in that a second detection means (50) for detecting graphic properties of the mailpieces (10) transported on the second conveying means (70) is linked to a means for printing the mailpieces (10), and a selection of areas on the surface of the mailpieces (10) to be printed on can be made as a function of information acquired in the second detection means (50).

18. The device according to claim 17,
characterized in that
the control means controls the activation of one of several means for printing the mailpiece (10).

19. The device according to one or both of claims 17 and 18,
characterized in that
it has at least one means for changing a transport route of the mailpieces (10) as a function of the result of the evaluation of the graphic information.

20. The device according to one or more of claims 17 to 19,
characterized in that
the printing means (60) comprises a means for printing mailpieces (10), whereby the means for printing the mailpieces (10) is configured in such a way that it has several printing areas, and in that the individual printing areas can be activated individually.

21. The device according to one or more of claims 17 to 20,
characterized in that
it comprises an imprint image arrangement with several individual imprint images, whereby the individual imprint images are essentially in the form of cancellation stamps (110).

22. The use of a device according to one or more of claims 17 to 21 for canceling mailpieces (10).

23. The use according to claim 22,
characterized in that
the activation of the printing areas is controlled in such a way that at least one cancellation mark (110) is applied onto each postage stamp (120).
